(19) United States
(12) Patent Application Publication
(10) Pub. No.: US 2012/0290415 A1
(43) Pub. Date: Nov. 15, 2012

(54) MOBILE IMAGE PAYMENT SYSTEM

(75) Inventor: Mark Itwaru, Toronto (CA)

(73) Assignee: RIAVERA CORP., Toronto (CA)

(21) Appl. No.: 13/105,803

(22) Filed: May 11, 2011

(51) Int. Cl. G06Q 30/00; G06Q 20/00

(52) U.S. Cl. 705/16; 705/26.41

(57) ABSTRACT

A Mobile Image Payment System (MIPS) for mobile commerce, which enables a Consumer to use a mobile device to make payments for online, Electronic Media, Print Media and POS Transactions. In an embodiment, the Consumer scans an encoded, mobile device scannable image that is displayed by a merchant, to initiate a transaction. The MIPS may complete the transaction by processing information between a Mobile Payment Client residing on the Consumer's mobile device, a Mobile Payment Interface residing on a Transaction Server, and, in a further embodiment, a Mobile Payment Application residing on a merchant's device or POS terminal. The Consumer's mobile device may communicate with a Payment Platform, which may communicate with a Merchant Transaction Server in order to process and complete the mobile transaction. The merchant MDSI can be displayed on any product or advertising medium.

### TECHNICAL FIELD

The present disclosure relates to a mobile device payment processing system.

### BACKGROUND

For years, the telecommunications, banking and payment processing industries have been trying to engineer a mobile transaction processing technology (predominantly for point of sale mobile transactions) that is secure, efficient and easy to use. Their inability to do so has effectively relegated the mobile transaction market to predominantly the purchase of downloadable items such as ringtones and music.

In addition, consumers' concerns over the security of mobile payment systems have hindered the widespread adoption of such technology. In traditional credit card or debit card based Point of Sale systems, when a consumer makes a purchase, the consumer's sensitive payment account information is generally processed between a merchant's POS Terminal and a Payment Platform (such as that of a credit card company, bank or other financial institution). Further, the consumer is typically required to enter personal identification numbers (“PINs”), or other such verification information such as passwords, on the merchant's POS Terminal. While such technology is widely adopted, in the case of mobile payment systems in particular, there remains a need to provide for enhanced security by removing much of such payment processing functions away from the merchant POS Terminal.

At the same time, developments in the field of mobile commerce are being facilitated by improved functionality and features available on mobile devices, and by such functionality and features becoming more commonplace on current mobile devices. For example, cell phones, smart phones and tablet computers nowadays are commonly integrated, multi-functional devices. In addition to their core, basic functionality, they will often have, or can be configured to have, web-enabled functionality, various other communication capabilities (e.g., e-mail, text, wi-fi, etc.), camera functions, scanning and graphical image handling functionalities and other capabilities.

### SUMMARY

Systems and methods for using a mobile device to facilitate a purchase directly from a TV screen, catalogue, an electronic billboard, poster or any type of electronic or print media, without having to place a phone call or manually browse to a website are disclosed herein. Furthermore systems and methods for using a mobile device, in an integrated manner, to facilitate registrations and/or purchases from a website are also disclosed herein. The embodiments disclosed here provide better solutions to the much sought-after mobile point of sale market which also opens up markets to mobile transaction processing that were never contemplated before—for example, the Electronic Media, Print Media, and e-commerce markets.

According to one embodiment, a method for enabling a consumer to perform, using a mobile device, a payment transaction with a merchant, comprises the steps of: scanning a mobile device scannable image using the mobile device, wherein the mobile device scannable image is encoded with merchant data; receiving the mobile device scannable image at a mobile payment client, the mobile payment client running on the mobile device; the mobile payment client decoding said mobile device scannable image into merchant data; the mobile payment client retrieving device data respecting the mobile device from said mobile device; the mobile payment client receiving a consumer payment request and a consumer payment account identifier entered by the consumer, wherein the consumer payment account identifier identifies a payment account of the consumer; the mobile payment client sending said merchant data, consumer payment request, consumer payment account identifier, and device data to a mobile payment interface, the mobile payment interface running on one or more transaction servers; the mobile payment interface using said device data and consumer payment account identifier to identify the consumer; the mobile payment interface creating a transaction request using said merchant data, consumer payment request and consumer payment account information; the mobile payment interface sending said transaction request to a payment platform; the payment platform approving the transaction request in the event the payment account of the consumer has sufficient funds to cover the amount of the payment transaction, and charging the amount of the payment transaction to the payment account of the consumer and crediting said amount to an account of the merchant; the payment platform sending to the mobile payment interface a notification of the approval or denial of the transaction request; and the mobile payment interface sending a confirmation of the approval or denial of the transaction request to the mobile payment client and to the merchant.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a simplified, schematic representation of the Mobile Image Payment System in operation, according to an embodiment, which illustrates the exemplary steps involved when a Consumer wishes to make a purchase with his/her mobile device using the payment system.

### DETAILED DESCRIPTION

A Mobile Image Payment System (MIPS) for mobile commerce enables a Consumer to use a mobile device to make payments for online, Electronic Media, Print Media, POS Transactions and the like. The Consumer may scan an encoded, mobile device scannable image (MDSI) that is displayed by a merchant, to initiate a transaction. The MIPS may then complete the transaction by processing information between a Mobile Payment Client (MPC) residing on the Consumer's mobile device, a Mobile Payment Interface (MPI) residing on a Transaction Server and optionally a Mobile Payment Application residing on a merchant's device or POS terminal.

The present system is configured to enable a Consumer's mobile device to communicate with a Payment Platform and a Payment Platform to communicate with a Merchant Transaction Server in order to process and complete the mobile transaction. The merchant MDSI can be displayed on any product or advertising medium (e.g., television screens, websites, print media, vending machines, points of sale terminals, etc.), opening up new sales and marketing opportunities for merchants. The MIPS provides a unique, secure and consistent transaction process.

One significant aspect of the disclosed system and method is that the Consumer may scan an MDSI to initiate a transaction, as opposed to the typical mobile commerce transaction approach where usually it is the merchant that scans an image on a Consumer's mobile device to initiate a transaction. The latter approach necessitates the merchant having a relatively sophisticated device that is capable of scanning an image on a Consumers' mobile device. Since “passive” media such as billboard, parking tickets, TV commercials, etc., are not capable of scanning a mobile device, this approach effectively eliminates most “passive” medium or devices from being used as part of a mobile transaction process.

The present system enables almost any object that can present an MDSI to be used to initiate a mobile transaction. The MIPS provides consumers with a consistent transaction process regardless of where a transaction originates (i.e., on the Internet, at a POS, on a television screen, on print media, etc.). After registering with the MIPS, a Consumer only needs to do the following to process a transaction: (1) Launch the MIPS application on his/her mobile device; (2) Capture the MDSI displayed by the merchant; (3) Select the transaction particulars (e.g., for a purchase, the Consumer may select the preferred payment account such as credit, debit, E-wallet, etc.; for an ATM machine transaction, the Consumer may select the transaction type such as withdrawal, deposit, account balance, etc.; and for a restaurant, the Consumer can select the tip amount); (4) Confirm the transaction; and (5) Optionally, confirm that the order fulfillment information may be automatically provided to the merchant. All of the backend fulfillment process is handled by the MIPS (e.g., delivery/pickup instructions, payment processing, etc.).

### MIPS Applications in E-Commerce

Disclosed herein is a system (sometimes referred to as a Mobile Image Processing System or MIPS) that marries mobile commerce with e-commerce in ways never anticipated before while simultaneously addressing two of the most persistent issues in e-commerce: shopper confidence and abandoned sales.

The conventional industry approach to marrying mobile commerce and e-commerce has been to make mobile devices web capable. This is to say that the general trend in the technology industry has been to develop technologies that allow a Consumer to browse and shop from websites via his/her mobile device. A standard e-commerce purchase allows a Consumer to use a personal computer to access the Internet, browse to a website, shop online, fill out any forms that the merchant needs to complete the transaction and finally pay for the purchase online. The embodiments disclosed herein make a mobile device complementary to a standard e-commerce purchase. This is done by allowing the Consumer to use the MIPS to facilitate the payment and form fill out components of an online transaction.

In addition, as previously mentioned, some Consumers are reluctant or unwilling to shop online due to real and perceived security concerns associated with exposing personal Payment Account information online. The embodiments disclosed herein provide Consumers the ability to pay for online purchases by processing a transaction via his/her mobile device, without requiring the Consumer to expose any of his/her Payment Account information online. In addition, the MIPS solution can expedite the checkout procedure by auto-populating any online forms that need to be filled out as part of the online purchase process.

### Exemplary MIPS Embodiment

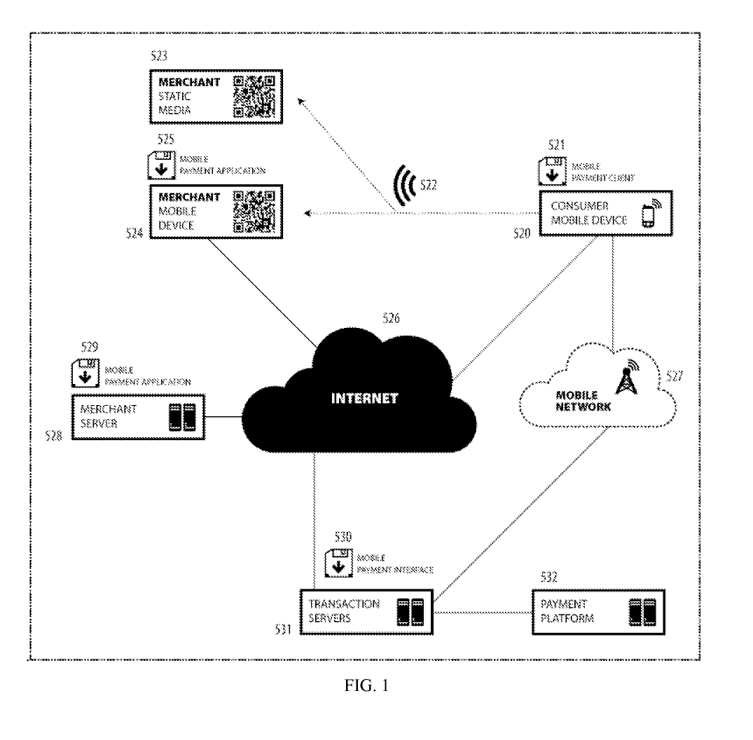

As illustrated in FIG. 1, a MIPS may consist of: a Mobile Payment Interface (MPI) 530 that resides on a Transaction Server 531, which can be configured to enable the MPI 530 to communicate with the Mobile Payment Client (MPC) 521 and the Payment Platform 532. The Transaction Server can also house the merchant profile information; the consumer profile information (e.g., name, address, phone number, e-mail address, Payment Account Information, etc.); allow the consumer to access his/her account via the web; allow the Payment Platform 532 to communicate with the MPC 521 and the MPI 530.

A MPC 521, which resides on the consumer's mobile device 520 can be used to: capture/scan the MDSI information; create a Transaction on the Payment Platform; communicate with the Payment Platform; communicate with the Merchant Transaction Server; provide Consumers with transaction options (e.g., buy, decline transaction, send personal information, go to merchant website, more info, etc.); provide customized process flows based on the merchant type (e.g., prompt for a tip if the merchant is identified as a restaurant, bypass user confirmation of a transaction for transactions under a certain price, prompt the user to send personal information to the merchant in order to auto-populate any forms that the merchant may need filled out, etc.); allow the Consumer to select his/her desired Payment Account (e.g., credit, debit, chequing, E-wallet, coupon, gift card, etc.); and allow the Consumer to log in to his/her account for account maintenance purposes.

A Mobile Payment Application MPA 525 can reside on a merchant mobile device 524 and can be used to: receive payment confirmations/declines from the MPI 530; generate a MDSI “on the fly” that includes the transaction ID, merchant ID (merchant's name and merchant's URL can also be provided), item(s) purchased, and price.

### MIPS Applications in Print Media and Electronic Media Commerce

Amongst its many other benefits, the MIPS can marry mobile commerce with Electronic Media, and Print Media commerce in ways never thought possible before. Electronic media includes, but is not limited to, television, electronic billboards, and video display terminals. Print Media includes, but is not limited to, magazines, newspapers, catalogues, telephone directories, parking ticket and utility bills. The MIPS can provide a marked improvement over the current Electronic and Print Media sales and advertising model. Currently, in order to make a purchase of goods and/or services, or to register for a service advertised via Electronic or Print Media, a consumer is required to: place a phone call to the merchant or a call center and provide the customer service representative with his/her personal information and Payment Account Information. Optionally, the Consumer has to browse to a website and provide his/her personal information and Payment Account Information online. In either scenario the Consumer is obliged to go through a time consuming process that requires him/her to provide his/her personal information and expose his/her Payment Account Information to the merchant.

The MIPS addresses these problems by allowing a Consumer to initiate a purchase transaction by scanning the MDSI displayed by the particular Electronic or Print Media. The rest of the transaction is completed on the Consumer's mobile device, without requiring the Consumer to place a phone call or fill out personal information and/or Payment Account Information on the merchant's site.

The MIPS benefits the merchant, in that it allows the merchant to save money by not requiring the merchant to have a call center to process orders. It also benefits the merchant by providing Consumers with a simplified transaction process, which in turn can reduce abandoned registrations and purchases. The MIPS benefits the Consumer by safeguarding the Consumer's Payment Account Information and by providing the Consumer with a significantly more simplified payment/registration process.

### MIPS Applications for Point of Sale Transactions

A Point of Sale Transaction may be a retail POS terminal, ATM machine or similar device. The MIPS can provide Consumers with a consistent transaction process regardless of the transaction type (i.e. POS, Print Media, Electronic Media or e-commerce).

Within the context of retail POS Terminals, the MIPS can provide Consumers the comfort of not having to expose Payment Account Information to a cashier at checkout. It can also provide the merchant with the benefit of not having to handle cash, thereby reducing the risk of employee theft. Under the MIPS, it is the Consumer that carries out the image scanning using his/her mobile device. This can save the merchant money by not requiring it to purchase/install any image scanning devices. Furthermore, the MIPS may benefit the merchant by expediting the payment and customer information gathering processes at checkout.

Within the context of ATM machines, the MIPS can provide security in not requiring a Consumer to enter his/her PIN at an ATM terminal. In an increasingly health conscious world, it can provide an additional hygiene benefit of not requiring a Consumer to touch a key pad at a public ATM machine. The MIPS technology can also provide the ATM operator with a cheaper mobile payment processing service, in that it does not require the ATM machine to be outfitted with an image scanning device.

The MIPS disclosed herein facilitates mobile commerce by allowing a mobile device to be used to process transactions originating either online, via Electronic Media or Print Media and from POS Terminals. Thus, Consumers are provided with a consistent transaction process regardless of where the transaction originates. When the MIPS is used in operation, the Consumer may use his/her mobile device to scan a MDSI, displayed and made available by a merchant, to initiate a transaction process. The MDSI may be in the form of a graphical image, such as a 2-D barcode or hologram, which encodes information relating to a particular Transaction and/or a particular merchant.

The MIPS may generally comprise certain computer software applications each of which run on certain physical components of the transaction network, and which are configured to be able to communicate, and to share information, with each other, where appropriate, as further described herein. More specifically, these software applications may include a MPC 521 running on the Consumer's mobile device 521 and a MPI 530 running on the Transaction Server(s) 531. In the scenario where the MIPS is utilized to enable a Consumer to effect a Print Media or Electronic Media commerce Transaction using his/her mobile device, a suitable pre-encoded MDSI may be simply presented on said media (there is no need to have a software application to generate a Transaction-specific MDSI “on the fly”). In the scenario where the MIPS is utilized to enable a Consumer to effect an e-commerce Transaction (e.g., an online purchase) using his/her mobile device, a software application for generating a suitable MDSI may reside either on the Consumer's computer or the Merchant's e-commerce server 528, and the generated MDSI can be displayed on the Consumer's computer screen for scanning. In the scenario where the MIPS is utilized to enable a Consumer to make a purchase using his/her mobile device 520 at a POS Terminal, the MIPS additionally may comprise a Mobile Payment Application (MPA) 529 running on the merchant POS Terminal.

The following describes the steps involved in a simple online or POS transaction utilizing the MIPS, according to an embodiment.

Step 1. The Consumer may select item(s) to be purchased on a merchant website or in a store.

Step 2. The Consumer may select “checkout” (or the equivalent thereof) or go to the cashier.

Step 3. The MPA 525 on the merchant device 524 may be sent the “shopping cart” information (or in the case of a POS transaction, the cash register information) and generate an MDSI containing all the particulars of the purchase.

Step 4. The MDSI may be displayed either on a computer screen or, in the case of a POS transaction, merchant display terminal.

Step 5. The Consumer can launch the Mobile Payment Client or MPC 521 on his/her mobile device and scan the MDSI.

Step 6. The MPC 521 can read the MDSI and communicates with the Mobile Payment Interface or MPI 530 to identify the merchant.

Step 7. The Consumer may be presented a list of options including “BUY NOW”.

Step 8. The Consumer can select “BUY NOW”.

Step 9. The MPC 521 can then prompt the Consumer to select the payment account type and provide login information such as a PIN number.

Step 10. The MPC 521 may communicate with the Payment Platform 532 via the MPI 530 to authenticate the Consumer and to process the payment.

Step 11. In the event that there are sufficient funds/credit in the Consumer's account, the MPC 521 can prompt the user to send the Order Form Data to the merchant.

Step 12. The Consumer may select “YES” and the MPC 521 sends the Order Form Data and the payment confirmation to the MPA 525 running on the merchant device.

Step 13. By communicating with the MPC 521, the MPI 530 can notify the Consumer of a successful Transaction and e-mail a receipt to the Consumer's registered e-mail address. In the case of a POS transaction, a paper receipt can be given to the Consumer. The Transaction is now complete.

In the case of Electronic Media, Print Media and other “static” applications, a pre-encoded MDSI that contains information that is specific to the transaction (e.g., merchant ID, merchant name, product(s) name, product(s) price, total, merchant URL, etc.) can be presented on the Electronic Media or Print media, without requiring a transaction-specific MDSI to be generated “on the fly.”

The steps involved in another exemplary payment transaction utilizing the MIPS, according to an embodiment, are described below, with reference to FIG. 1.

Step 1. The Consumer can select item(s) to be purchased on a merchant website or in a store.

Step 2. The Consumer can select “checkout” (or the equivalent there of) or go to the cashier.

Step 3. The MPA 525 on the merchant device 524 can be sent the “shopping cart” information (or in the case of a POS transaction, the cash register information) and generate an MDSI containing the particulars of the purchase (e.g., transaction amount, taxes, etc.) and information about the merchant (e.g., merchant identifier(s), merchant authentication credentials, etc.).

Step 4. The MDSI can be displayed either on a computer screen (not specifically shown in FIG. 1) or, in the case of a POS transaction, the display of the merchant POS Terminal or merchant device 524.

Step 5. The Consumer can launch the MPC 521 on his/her mobile device 520 and scan 522 the MDSI.

Step 6. The MPC 521 can read the MDSI and decode the data encoded in the MDSI in order to extract the merchant data (such as merchant ID, transaction ID, amount of purchase and any other pertinent information, etc.).

Step 7. The MPC 521 can open a secure encrypted communications channel with the MPI 530 (the MPI 530 running on transaction server 531) via the Internet 526 or other intermediary communications network (e.g., 527). All further communication with the MPI 530 can be via this secure channel.

Step 8. The MPC 521 can authenticate itself with the MPI 530 using previously agreed upon and configured credentials that tie the mobile device 520 to an individual consumer.

Step 9. The MPI 530 may validate the authentication credentials of the MPC 521 against a database of known (registered) mobile devices and consumers.

Step 10. Upon successful authentication, the MPC 521 can pass the scanned MDSI data to the MPI 530 to initiate the purchasing process.

Step 11. The MPI can validate the MDSI data for correctness (e.g., merchant information, transaction amounts, etc.), retrieve the merchant information and begin a new purchase transaction. The MDSI may be encoded with unique information that is only relevant to the MPI, such as for example, a unique merchant ID identifying the merchant and said merchant's profile on the transaction server 531. The merchant profile may contain all relevant information pertaining to the merchant including but not limited to: secure connection instructions, merchant inventory list, address, contact information, merchant account information, passwords, access instructions, merchant implementation specifics, policies and procedures pertaining to the merchant.

Step 12. The MPI 530 can look up the available payment methods for the Consumer and return this along with the transaction details to the MPC 521. The available methods will depend on options available to the particular Consumer. Typical payment methods include but are not limited to: E-wallet, coupon, gift-card, debit and credit card. Additional limitations on the options will be imposed based on funds available for each of the configured methods, currency, transaction amount or other parameters. In the case of gift-cards or coupons, the funds available to the Consumer can be altered based on pre-defined properties of the coupon or gift-card. For example, a gift-card for Merchant X entered in the Consumer's account on the Payment Platform could only increase the funds available to the Consumer when a purchase is being made at Merchant X.

Step 13. The MPC 521 displays a summary of the transaction to be completed (e.g., amounts, quantities, merchant identity, etc.) on the Consumer's mobile device 520.

Step 14. In an embodiment, additional input fields may be presented to the Consumer by the MPC 521. For example, in the case of a restaurant or taxi purchase there will typically be the desire to allow the Consumer to add an additional “tip” to the total transaction amount.

Step 15. The MPC 521 can display the payment methods available to the Consumer along with the transaction details from step 13 and, if applicable, step 14.

Step 16. The Consumer can select his/her preferred payment method and provide any additional payment authentication data, such as a PIN number or password.

Step 17. The MPC 521 may communicate with the Payment Platform 532 via the MPI 530 to authenticate the Consumer and to process the payment.

Step 18. Upon successful authentication of the PIN, the Payment Platform 532 can then perform the requested financial transactions to charge the amount of the transaction to the Consumer's Payment Account and credit that amount to the merchant's account.

Step 19. Upon successful completion of the transaction, the MPC 521 may prompt the Consumer to send Order Form Data to the merchant in situations where it may be required (e.g., to provide a shipping address for hard goods).

Step 20. The Consumer can select “YES” and the MPC 521 instructs the MPI 530 to send the Order Form Data to a Mobile Payment Application 529 running on the Merchant Transaction Server 528.

Step 21. The MPI 530 can notify the MPA 525 on the merchant POS Terminal of Transaction completion by transmitting the Transaction information, including but not limited to the following:

Date and time;

merchant name;

Transaction ID;

Transaction amount;

Transaction status (approved/declined); and

Any other identifying information required by the merchant and governing POS standards.

While the Transaction information is described herein as being transmitted to the MPA 525 on the merchant POS Terminal, it should be appreciated that this may also be transmitted indirectly to the MPA 525 on the merchant POS Terminal, i.e., the Transaction information may be transmitted to a MPA 529 running on a Merchant Transaction Server 528, to be passed on to the MPA 525.

Step 22. The MPI 530 may also notify the MPC 521 with the same information as was transmitted to the merchant (step 21).

Step 23. The MPI 530 may notify the Consumer of Transaction completion and e-mail a receipt to the Consumer's registered e-mail address. In the case of a POS transaction, a paper receipt can be given to the Consumer. The Transaction is now complete.

In an alternative embodiment, the MIPS can also be similarly utilized to facilitate purchases of items from Electronic Media, Print Media and other “static” applications. In these cases, a pre-encoded MDSI that contains information that is specific to the transaction (e.g., merchant ID, merchant name, product(s) name, product(s) price, total, merchant URL, etc.) can be presented on such Electronic Media or Print Media for scanning by the Consumer's mobile device. The steps for this alternative embodiment would be largely identical to those described in the exemplary method above, except that steps 1-4 above would be substituted by:

Step 1. A pre-encoded MDSI containing information specific to a Transaction (e.g., merchant ID, merchant name, product(s) name, product(s) price, total, merchant URL, etc.) can be presented on Electronic Media or Print Media 523 for scanning by the Consumer's mobile device 520.

It should be appreciated that in the case of an embodiment such as one involving Print Media, where there is no MPA running on a merchant POS Terminal, step 21 would be modified as follows:

Step 21. The MPI 530 may notify the MPA 529 on the Merchant Transaction Server 528 of Transaction completion by transmitting the Transaction information, including the following:

Date and time;

merchant name;

Transaction ID;

Transaction amount;

Transaction status (approved/declined); and

Any other identifying information required by the merchant.

### GLOSSARY

For the purposes of this disclosure, the following terms have been ascribed the following meanings:

Consumer—the mobile device user, the individual making a purchase at a POS.

Electronic Media—Television, Electronic billboards, computer terminals, video display terminals, movies and video projections, and the like.

E-wallet—any electronic stored value system.

MDSI—Mobile Device scannable image.

Mobile device—any wireless, web-enabled electronic device, including cell phone, electronic PDA, computer tablet, smartphone or a similar device.

MPA—Mobile Payment Application.

MPC—Mobile Payment Client.

MPI—Mobile Payment Interface.

Order Form Data—any Consumer information including, but not limited to, address, phone number, e-mail address, billing address, shipping address and date of birth.

Payment Account—an account held by a Consumer with a financial institution, E-wallet provider, Credit Issuing Company, or the like.

Payment Account Information—information pertaining to a Payment Account, including but not limited to account numbers, account balances, passwords and PIN numbers.

Payment Platform—the computing infrastructure utilized by banks, other financial institutions, E-wallet service providers, money transfer service providers, or the like, that is used to authenticate account holders and/house account holder accounts and process electronic payment from account holder accounts.

POS or Point of Sale—the location where a purchase/sale transaction takes place.

POS Markets—vending machines, bill payments, ATM machines, parking tickets, any MDSI enabled product.

POS Terminal or Point of Sale Terminal—any type of electronic payment terminal or transaction terminal including but not limited to ATM machines, vending machines and standard in-store point of sale terminals.

Print Media—Parking tickets, magazines, newspapers, telephone directories, utility invoices, catalogues, posters, billboards, flyers, and the like.

Transaction—the purchase of goods or services, the registration for a service or membership, an ATM transaction or a point of sale transaction.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

1. A method for enabling a consumer to perform, using a mobile device, a payment transaction with a merchant, the method comprising the steps of:
receiving merchant data at a mobile payment client, the mobile payment client running on the mobile device, and the merchant data associated with a payment account of the merchant;
receiving, by the mobile client, a consumer payment account identifier selected by the consumer, wherein the consumer payment account identifier identifies a payment account of the consumer;
sending, by the mobile client, a consumer payment request having transaction information of the merchant data and the consumer payment account identifier directly to a mobile payment interface, the mobile payment interface running on one or more transaction servers, such that the payment transaction associated with the consumer payment request is completed by the mobile payment client without submitting the consumer payment account identifier to the merchant;
and
receiving, by the mobile client, from the mobile payment interface, a confirmation of approval or denial of a transaction request submitted by the mobile payment interface to a payment platform based on the transaction information of the consumer payment request;
wherein the payment platform approves the transaction request in the event the payment account of the consumer identified by the consumer payment account identifier has sufficient funds to cover an amount of the payment transaction, and charges the amount of the payment transaction to the payment account of the consumer and credits the amount to the payment account of the merchant associated with the merchant data.

2. The method of claim 1, wherein the merchant data is encoded in a mobile device scannable image is presented on a point of sale terminal for scanning.

3. The method of claim 2, wherein the mobile device scannable image is generated by a mobile payment application, the mobile payment application running on the point of sale terminal.

4. The method of claim 3, wherein a confirmation of the approval or denial of the transaction is sent by the mobile payment interface after completion of the transaction to the mobile payment application running on the point of sale terminal.

5. The method of claim 1, wherein the payment account of the consumer identified by the consumer payment account identifier is selected from the group consisting of: a credit card account, a debit card account, an E-wallet account, and other electronic stored value account.

6. The method of claim 1, further comprising the steps of, before the mobile payment interface sends the transaction request to the payment platform:
(i) the mobile payment client prompting the consumer to enter a PIN number or password associated with the payment account of the consumer using a keypad of the mobile device, rather than requiring the consumer to enter the PIN number or password at a terminal of the merchant;
(ii) the mobile payment client receiving said PIN number or password; and
(iii) the mobile payment client sending said PIN number or password to the mobile payment interface.

7. The method of claim 1, wherein the payment account identifier also identifies corresponding payment account information of the consumer, and wherein said payment account information is stored on the one or more transaction servers.

8. The method of claim 1, wherein said mobile device scannable image is encoded with unique information that is only relevant to the mobile payment interface.

9. The method of claim 1, wherein said merchant data includes one or more selected from the group of: transaction ID, merchant ID, price and purchased item information.

10. The method of claim 1, wherein the consumer payment request includes device data respecting the mobile device, the device data includes one or more selected from the group of: International Mobile Equipment Identity (IMEI) number, phone number, carrier name and geographic location co-ordinates.

11. The method of claim 1, wherein said transaction request comprises one or more selected from the group of: purchase amount; credit card data and PIN; debit card data and PIN; and stored value account and login information.

12. The method of claim 2, wherein the mobile device scannable image is presented on print media or electronic media for scanning.

13. A system for enabling a consumer to perform, using a mobile device, a payment transaction with a merchant, comprising:
a mobile payment client running on the mobile device and configured to receive merchant data associated with a payment account of the merchant; and
a mobile payment interface running on a transaction server;
wherein the mobile payment client and the mobile payment interface are configured to be able to send information to, and receive information from, each other;
wherein the mobile payment interface is configured to send information to, and receive information from, a payment platform;
wherein the mobile payment client
(i) receives a consumer payment account identifier selected by the consumer, wherein the consumer payment account identifier identifies a payment account of the consumer, and
(ii) sends a consumer payment request having transaction information of the merchant data and the consumer payment account identifier directly to the mobile payment interface, the mobile payment interface running on one or more transaction servers, such that the payment transaction associated with the consumer payment request is completed by the mobile payment client without submitting the consumer payment account identifier to the merchant;
and wherein the mobile payment interface
(i) receives the transaction information,
(ii) uses the consumer payment account identifier to identify the consumer,
(iii) creates a transaction request using the merchant data and the consumer payment account identifier,
(iv) sends said transaction request to the payment platform,
(v) receives from said payment platform a transaction approval, in the event that a payment account of the consumer associated with the consumer payment identifier has sufficient funds to cover an amount of the payment transaction, the payment platform configured to charge the amount of the payment transaction to the payment account of the consumer and credit said amount to the payment account of the merchant, or a transaction denial, in the event that the payment account of the consumer does not have sufficient funds to cover the amount of the payment transaction, and
(vi) sends confirmation of the transaction approval or denial to the mobile payment client and to the merchant.

14. The system claim 13, wherein merchant data is encoded in a mobile device scannable image is presented on a point of sale terminal for scanning.

15. The system of claim 14, wherein the mobile device scannable image is generated by a mobile payment application, the mobile payment application running on the point of sale terminal.

16. The system of claim 15, wherein the confirmation of the transaction approval or denial sent by the mobile payment interface to the merchant is sent to the mobile payment application running on the point of sale terminal.

17. The system of claim 15, wherein the payment account of the consumer associated with the consumer payment identifier is selected from the group consisting of: a credit card account, a debit card account, an E-wallet account or other electronic stored value account.

18. The system of claim 15, wherein:
before the mobile payment interface sends the transaction request to the payment platform:
(i) the mobile payment client prompts the consumer to enter a PIN number or password associated with the payment account of the consumer;
(ii) the mobile payment client receives said PIN number or password; and
(iii) the mobile payment client sends said PIN number or password to the mobile payment interface;
and wherein:
(i) the mobile payment interface sends said PIN number or password to the payment platform; and
(ii) the payment platform authenticates the payment account using said PIN number or password.

19.-22. (canceled)

23. A non-transitory computer-readable storage medium with an executable program application stored thereon, the program application configured for coordinating a consumer to perform a payment transaction associated with a merchant, the program application configured as a client of a mobile payment interface accessible over a communications network, wherein the program application instructs a computer processor to perform the following steps of:
receiving merchant data associated with a payment account of the merchant;
receiving a consumer payment account identifier selected by the consumer, wherein the consumer payment account identifier identifies a payment account of the consumer;
sending a consumer payment request having transaction information of the merchant data and the consumer payment account identifier directly to the mobile payment interface, the mobile payment interface running on one or more transaction servers, such that the payment transaction associated with the consumer payment request is completed without submitting the consumer payment account identifier to the merchant; and
receiving from the mobile payment interface a confirmation of approval or denial of a transaction request submitted by the mobile payment interface to a payment platform based on the transaction information of the consumer payment request;
wherein the payment platform provides for approval of the transaction request in the event the payment account of the consumer identified by the consumer payment account identifier has sufficient funds to cover an amount of the payment transaction and charges the amount of the payment transaction to the payment account of the consumer and credits the amount to the payment account of the merchant associated with the merchant data.

24. The non-transitory computer-readable storage medium of claim 23, wherein the merchant data is encoded in a mobile device scannable image presented on a point of sale terminal for scanning.

25. The non-transitory computer-readable storage medium of claim 24, wherein the mobile device scannable image is generated by a mobile payment application, the mobile payment application running on the point of sale terminal.

26. The non-transitory computer-readable storage medium of claim 24, wherein the mobile device scannable image is presented on print media or electronic media for scanning.
